(19) United States
(12) Patent Application Publication
(10) Pub. No.: US 2022/0406188 A1
(43) Pub. Date: Dec. 22, 2022

(54) ALERT CONTROL APPARATUS, MOVABLE OBJECT, ALERT CONTROL METHOD, AND COMPUTER READABLE STORAGE MEDIUM

(71) Applicant: HONDA MOTOR CO.,LTD., Tokyo (JP)

(72) Inventors: Moriya HORIUCHI, Saitama (JP); Shigeru INOUE, Saitama (JP); Takahiro KUREHASHI, Saitama (JP); Yuta SAKAGAWA, Saitama (JP)

(21) Appl. No.: 17/834,867

(22) Filed: Jun. 7, 2022

(30) Foreign Application Priority Data
Jun. 18, 2021 (JP) 2021-101633

(51) Int. Cl. G08G 1/16; G08G 1/01; H04W 4/90; H04W 4/12; H04W 4/02; G06V 20/58

(52) U.S. Cl. CPC G08G 1/164; G08G 1/166; G08G 1/0141; G08G 1/0145; G08G 1/0133; H04W 4/90; H04W 4/12; H04W 4/025; G06V 20/58

(57) ABSTRACT

An alert control apparatus includes an obtaining unit configured to obtain recognition information including position information of each of a plurality of targets present outside a movable object, a risk level decision unit configured to decide a risk level for each of the plurality of targets to approach the movable object, a selection unit configured to select a plurality of targets corresponding to alert targets based on the risk level decided by the risk level decision unit, a classification unit configured to classify the plurality of targets selected by the selection unit into one or more groups based on the position information of each of the plurality of targets selected by the selection unit, and a transmission control unit configured to perform control to transmit alert information including position information of the one or more groups.

The contents of the following Japanese patent application(s) are incorporated herein by reference:

NO. 2021-101633 filed on Jun. 18, 2021.

### BACKGROUND

### 1. Technical Field

The present invention relates to an alert control apparatus, a movable object, an alert control method, and a computer readable storage medium.

### 2. Related Art

Patent document 1 describes that regarding a pedestrian terminal apparatus, it is judged, based on position information of its own apparatus and position information of another pedestrian terminal apparatus included in notification information, whether a pedestrian possessing its own apparatus is located inside a pedestrian group, and communication between the pedestrian and a vehicle is to be stopped when the pedestrian is located inside the pedestrian group.

### LIST OF CITED REFERENCES

Patent document 1: Japanese Patent Application Publication No. 2017-111741

### BRIEF DESCRIPTION OF THE DRAWINGS

FIG. 1 schematically illustrates a usage scene of an alert system 10.

FIG. 2 illustrates a system configuration of a vehicle 20.

FIG. 3 is an explanatory diagram for describing an example of position information of a group included in alert information transmitted by a transmission control unit 250.

FIG. 4 is an explanatory diagram for describing another example of the position information of the group included in the alert information transmitted by the transmission control unit 250.

FIG. 5 schematically illustrates a flow of processing related to an alert control method executed by the vehicle 20 and a terminal 82.

FIG. 6 schematically illustrates a flow of other processing related to the alert control method executed by the vehicle 20, a server 52, and the terminal 82.

FIG. 7 is a flowchart related to processing for classifying a pedestrian 80 into a group.

FIG. 8 illustrates an example of a computer 2000.

### DESCRIPTION OF EXEMPLARY EMBODIMENTS

Hereinafter, the present invention will be described through embodiments of the invention, but the following embodiments do not limit the invention according to the claims. In addition, not all combinations of the features described in the embodiments necessarily have to be essential to solving means of the invention.

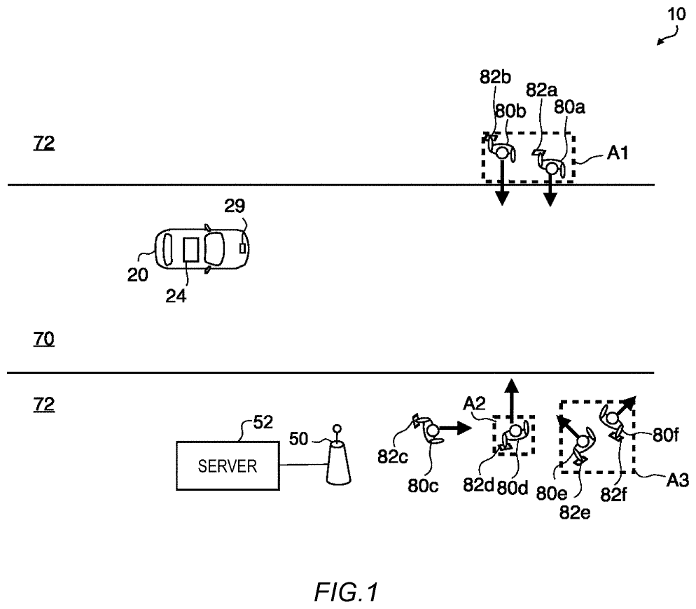

FIG. 1 schematically illustrates a usage scene of an alert system 10. The alert system 10 includes a vehicle 20, a base transceiver station 50, and a server 52, and a terminal 82a, a terminal 82b, a terminal 82c, a terminal 82d, a terminal 82e, and a terminal 82f.

The terminal 82a is a terminal possessed by a pedestrian 80a. The terminal 82b is a terminal possessed by a pedestrian 80b. The terminal 82c is a terminal possessed by a pedestrian 80c. The terminal 82d is a terminal possessed by a pedestrian 80d. The terminal 82e is a terminal possessed by a pedestrian 80e. The terminal 82f is a terminal possessed by a pedestrian 80f. A terminal 82 is configured to perform mobile communication through the base transceiver station 50. The terminal 82a, the terminal 82b, the terminal 82c, the terminal 82d, the terminal 82e, and the terminal 82f are configured to receive various types of services provided through the server 52 connected to the base transceiver station 50. The server 52 may include, for example, an edge computing server such as an MEC server. It should be noted that the terminal 82a, the terminal 82b, the terminal 82c, the terminal 82d, the terminal 82e, and the terminal 82f may be collectively referred to as the “terminal 82”. The pedestrian 80a, the pedestrian 80b, the pedestrian 80c, the pedestrian 80d, the pedestrian 80e, and the pedestrian 80f may be collectively referred to as a “pedestrian 80”. The vehicle 20 is an example of a “movable object”.

In the alert system 10, the vehicle 20 is configured to transmit alert information for outputting alert information from the terminal 82 when the pedestrian 80 having a risk of approaching the vehicle 20 is present. When the alert information is received, the terminal 82 alerts the pedestrian 80 by an alert display, a sound, vibration, or the like. Thus, the pedestrian 80 is notified that the vehicle 20 is approaching.

The terminal 82 may be a mobile terminal such as a mobile phone or a smartphone. The terminal 82 includes a positioning function. The terminal 82 receives radio waves emitted from a global navigation satellite system (GNSS) satellite, for example, and measures a current position of the terminal 82 based on the radio waves emitted from the GNSS satellite. The terminal 82 periodically updates the current position of the terminal 82 by periodically performing positioning.

According to the present embodiment, a case will be mainly considered and described where a target having a risk of approaching the vehicle 20 is a “pedestrian”. However, the target having the risk of approaching the vehicle 20 may be another movable object or vehicle. In this case, the “terminal” may be a communication apparatus such as a telematics control unit (TCU) provided in the other vehicle.

The vehicle 20 includes a sensor 29 and an alert control apparatus 24. The sensor 29 includes a camera and a radar. The sensor 29 is configured to obtain information ahead of the vehicle 20. For example, the sensor 29 obtains an image ahead of the vehicle 20 and ranging information. The alert control apparatus 24 is configured to recognize an image obtained by the camera included in the sensor 29, and detect the pedestrian 80. In addition, the alert control apparatus 24 detects a current position of the pedestrian 80 based on the ranging information obtained by the radar and the current position of the vehicle 20. The alert control apparatus 24 identifies a movement direction or the like of the pedestrian 80 based on an orientation or the like of the pedestrian 80. The alert control apparatus 24 identifies the pedestrian 80 having a risk of approaching the vehicle 20, particularly, a possibility of moving onto an expected travelling path of the vehicle 20, based on the current position and the movement direction of the pedestrian 80.

For example, in a situation illustrated in FIG. 1, the vehicle 20 is travelling in a carriage way 70. Sidewalks 72 are provided on both sides of the carriage way 70. The alert control apparatus 24 recognizes a position of the pedestrian 80 walking in the sidewalk 72 from information detected by the sensor 29. The alert control apparatus 24 may identify the movement direction and the movement speed of the pedestrian 80 based on a temporal change of the position of the pedestrian 80, a temporal change of a distance from the vehicle 20 to the pedestrian 80, an orientation of a body of the pedestrian 80, and the like. It should be noted that arrows illustrated in FIG. 1 schematically illustrate movement speeds of the pedestrians 80.

The pedestrian 80a, the pedestrian 80b, and the pedestrian 80d are moving towards the carriage way 70, and when moving in a same direction without change, may enter the carriage way 70 during a period for the vehicle 20 to pass by. For this reason, the alert control apparatus 24 judges that a risk level for the pedestrian 80a, the pedestrian 80b, and the pedestrian 80d to approach the vehicle 20 is high (risk level “high”). The pedestrian 80c is moving in the sidewalk 72 in parallel to the carriage way 70. For this reason, the alert control apparatus 24 judges that a risk level for the pedestrian 80c to approach the vehicle 20 is low (risk level “low”). The pedestrian 80e and the pedestrian 80f are moving in the sidewalk 72 towards the carriage way 70, and may therefore enter the carriage way 70. However, the vehicle 20 is highly likely to pass by during a period for the pedestrian 80e and the pedestrian 80f to enter the carriage way 70. For this reason, the alert control apparatus 24 determines that a risk level for the pedestrians 80e and 80f to approach the vehicle 20 is an intermediate degree (risk level “moderate”).

The alert control apparatus 24 selects the pedestrians 80 whose risk levels have been judged as “high” or “moderate”, and classifies the selected pedestrians 80 into one or more groups. For example, the pedestrian 80a and the pedestrian 80b are located close to each other and moving in a direction of the carriage way 70, and also the judged risk levels are both “high”. For this reason, the alert control apparatus 24 classifies the pedestrian 80a and the pedestrian 80b into one group. In addition, the pedestrian 80e and the pedestrian 80f are located close to each other, movement directions have directional components towards the carriage way 70, and also the judged risk levels are both “moderate”. For this reason, the alert control apparatus 24 classifies the pedestrian 80e and the pedestrian 80f into one group. With regard to the pedestrian 80d, since other pedestrians whose risk levels have been judged as “high” are not present nearby, the alert control apparatus 24 classifies the pedestrian 80d into a sole group.

With regard to each of the three classified groups, the alert control apparatus 24 generates areas A1, A2, and A3 which include positions of all the pedestrians 80. To be specific, the alert control apparatus 24 generates first alert information including latitude and longitude information indicating a position of the area A1 where the pedestrian 80a and the pedestrian 80b have been recognized, second alert information including latitude and longitude information indicating a position of the area A2 where the pedestrian 80d has been recognized, and third alert information including latitude and longitude information indicating a position of the area A3 where the pedestrian 80e and the pedestrian 80f have been recognized. The alert control apparatus 24 transmits the first alert information, the second alert information, and the third alert information. For example, the alert control apparatus 24 transmits the first alert information, the second alert information, and the third alert information by broadcast.

The terminal 82a identifies the area A1 from the latitude and longitude information included in the received first alert information, and determines that a current position of the terminal 82a is included in the area A1. Therefore, the terminal 82a performs a warning output by an HMI function of the terminal 82a. Similarly, the terminal 82b determines that a current position of its own terminal is included in the area A1 identified from the received first alert information, and performs a warning output by an HMI function of its own terminal. In addition, the terminal 82d determines that a current position of its own terminal is included in the area A2 identified from the received second alert information, and performs a warning output by an HMI function of its own terminal. In addition, each of the terminal 82e and the terminal 82f determines that a current position of its own terminal is included in the area A3 identified from the received third alert information, and performs a warning output by an HMI function of its own terminal.

On the other hand, the terminal 82c determines that a position of its own terminal is not included in any area among the area A1, the area A2, and the area A3 indicated by the first alert information, the second alert information, and the third alert information which have been received. Thus, the terminal 82c determines that it is not necessary to perform an alert for the pedestrian 80c. For this reason, the terminal 82b discards the alert information without performing an alert output.

In this manner, in accordance with the alert system 10, instead of the transmission of the alert information to each of the pedestrian 80a, the pedestrian 80b, the pedestrian 80d, the pedestrian 80e, and the pedestrian 80f corresponding to transmission targets of the alert information, the alert control apparatus 24 can transmit the alert information by classifying the pedestrian 80a, the pedestrian 80b, the pedestrian 80d, the pedestrian 80e, and the pedestrian 80f into the three groups. For this reason, communication resource used to transmit the alert information can be reduced. Thus, even under a situation with the presence of a large number of the pedestrians 80 corresponding to the transmission targets of the alert information, a possibility that it is not possible to transmit the alert information can be decreased.

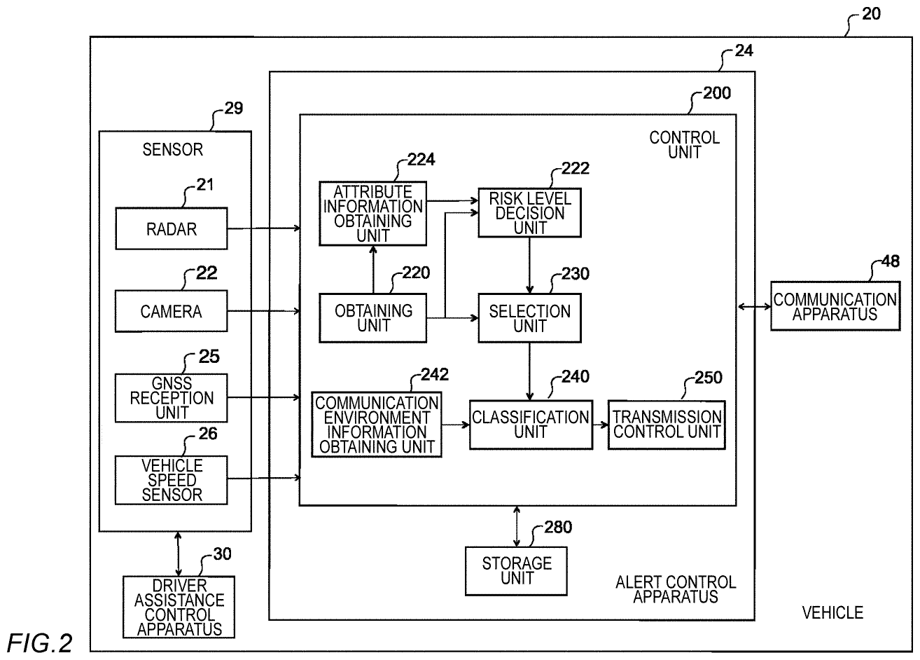

FIG. 2 illustrates a system configuration of the vehicle 20. The vehicle 20 includes the sensor 29, the alert control apparatus 24, and a driver assistance control apparatus 30.

The sensor 29 includes a radar 21, a camera 22, a GNSS reception unit 25, and a vehicle speed sensor 26. The radar 21 may be a LiDAR, a millimeter wave radar, or the like. The GNSS reception unit 25 is configured to receive radio waves emitted from a global navigation satellite system (GNSS) satellite. The GNSS reception unit 25 generates information indicating a current position of the vehicle 20 based on a signal received from the GNSS satellite. The camera 22 is configured to generate image information by picking up an image of a surrounding of the vehicle 20. For example, the camera 22 generates the image information by picking up an image in an advancing direction of the vehicle 20. The camera 22 is an example of an image pickup unit mounted on the vehicle 20. The vehicle speed sensor 26 is configured to detect a vehicle speed of the vehicle 20. It should be noted that the sensor 29 may include a position sensor such as an odometer, or an inertial measurement unit (IMU) such as an acceleration sensor or an orientation sensor.

The driver assistance control apparatus 30 is configured to perform driver assistance of the vehicle 20 by using information detected by the sensor 29. The driver assistance control apparatus 30 may be realized by an electronic control unit (ECU) having a function of advanced driver-assistance systems (ADAS).

The alert control apparatus 24 includes a control unit 200, a storage unit 280, and a communication apparatus 48. The control unit 200 is realized by an arithmetic processing apparatus including a processor, for example. The storage unit 280 is realized by including a nonvolatile storage medium. The control unit 200 is configured to perform processing by using information stored in the storage unit 280. The communication apparatus 48 is responsible for direct communication with the terminal 82. The control unit 200 may be realized by the ECU including a microcomputer provided with a CPU, a ROM, a RAM, an I/O, a bus, and the like.

The control unit 200 includes an obtaining unit 220, a risk level decision unit 222, a selection unit 230, a classification unit 240, an attribute information obtaining unit 224, a communication environment information obtaining unit 242, and a transmission control unit 250. It should be noted that a mode may be adopted in which the control unit 200 does not have a part of functions in a functional block illustrated in FIG. 2. For example, a mode may be adopted in which only a part of functions is implemented in the control unit 200, and the other function is implemented as a function of the sensor 29 or the other circuit.

The obtaining unit 220 is configured to obtain recognition information including position information of each of a plurality of targets present outside the vehicle 20. For example, the obtaining unit 220 obtains the recognition information by performing image recognition of an image picked up by the camera 22 mounted on the vehicle 20. To be specific, the obtaining unit 220 extracts a pedestrian having a risk of approaching the vehicle 20 by performing the image recognition of the image picked up by the camera 22. In addition, the obtaining unit 220 may obtain information of a distance to a pedestrian by the radar 21. The obtaining unit 220 may obtain the distance information to the pedestrian based on the image picked up by the camera 22. The obtaining unit 220 calculates a position of a target having a risk of approaching the vehicle 20 based on position information of the vehicle 20 and the information of the distance to the pedestrian.

The risk level decision unit 222 is configured to decide a risk level for each of a plurality of targets to approach the vehicle 20. The selection unit 230 is configured to select a plurality of targets corresponding to alert targets based on the risk level decided by the risk level decision unit 222. The classification unit 240 is configured to classify the plurality of targets selected by the selection unit 230 into one or more groups based on position information of each of the plurality of targets selected by the selection unit 230. The transmission control unit 250 is configured to perform control to transmit alert information including position information of one or more groups.

The recognition information includes position information and a movement direction of each of a plurality of targets present outside the vehicle 20, for example. The classification unit 240 classifies the plurality of targets selected by the selection unit 230 into one or more groups based on the position information and the movement direction of each of the plurality of targets selected by the selection unit 230. It should be noted that the obtaining unit 220 may obtain the movement direction based on an orientation of the recognized target. For example, the obtaining unit 220 may obtain the movement direction based on an orientation of a body of the recognized pedestrian.

The recognition information may include the position information, the movement direction, and a movement speed of each of the plurality of targets present the vehicle 20. The classification unit 240 may classify the plurality of targets selected by the selection unit 230 into one or more groups based on the position information, the movement direction, and the movement speed of each of the plurality of targets selected by the selection unit 230. It should be noted that the obtaining unit 220 obtains information related to the movement speed of the recognized target. For example, the obtaining unit 220 may obtain the movement speed based on a temporal change of a position of a target. The obtaining unit 220 may obtain a relative speed of the movement speed of the vehicle 20 detected by the vehicle speed sensor 26 to the recognized target. The obtaining unit 220 may obtain the relative speed between the recognized target and the vehicle 20 based on a temporal change of a distance to the recognized target.

The transmission control unit 250 is configured to perform control to transmit alert information including a plurality of pieces of coordinate information indicating an area including position information of a plurality of targets classified into each of the groups. The transmission control unit 250 may perform the control to transmit the alert information including center coordinates of the position information of the plurality of targets classified into each of the groups. The transmission control unit 250 may perform the control to transmit the alert information including at least a position of a target having the highest risk level decided by the risk level decision unit 222 among the plurality of targets classified into each of the groups.

The attribute information obtaining unit 224 is configured to obtain information indicating an age of each of a plurality of targets. The risk level decision unit 222 decides the risk level to be higher in a case where ages of the plurality of targets includes a predetermined age group as compared with a case where the ages of the plurality of targets does not include the predetermined age group. For example, the obtaining unit 220 recognizes whether the pedestrian 80 is a child by performing image recognition of an image picked by the camera 22. The attribute information obtaining unit 224 obtains a recognition result on whether the pedestrian is a child from the obtaining unit 220, and when attribute information obtaining unit 224 obtains the recognition result indicating that the pedestrian is a child, the risk level decision unit 222 decides the risk level to be high.

The communication environment information obtaining unit 242 is configured to obtain information indicating a communication environment. The classification unit 240 decides a number of at least one group for classifying the plurality of targets selected by the selection unit 230 based on the communication environment obtained by the communication environment information obtaining unit 242. For example, the communication environment information obtaining unit 242 obtains information indicating a congestion degree of the communication environment. The classification unit 240 decreases the number of groups for classifying the plurality of target selected by the selection unit 230 as the congestion degree obtained by the communication environment information obtaining unit 242 is higher. The information indicating the congestion degree of the communication environment may be delay time information of communication, communication speed information, a packet loss rate, or the like.

It should be noted that the transmission control unit 250 performs the control to transmit the alert information without designating a destination. For example, the transmission control unit 250 may transmit the alert information from the communication apparatus 48 by broadcast based on direct communication. It should be noted that the transmission control unit 250 may perform the control to transmit the alert information to the server 52 configured to manage the position information of the plurality of terminals 82, and transmit the alert information to the terminal 82 through the server 52. It should be noted that the transmission control unit 250 may transmit the alert information to the communication apparatus 48 by directional communication. For example, the communication apparatus 48 may have a directional antenna, and the transmission control unit 250 may transmit the alert information to the communication apparatus 48 towards a position of the recognized target.

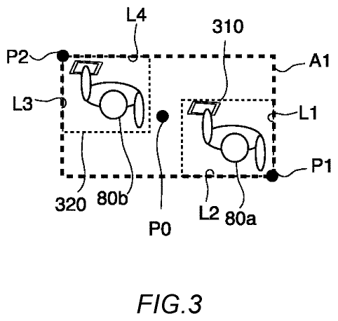

FIG. 3 is an explanatory diagram for describing an example of position information of a group included in the alert information transmitted by the transmission control unit 250. With reference to FIG. 3, position information of the area A1 of the group including the pedestrian 80a and the pedestrian 80b will be described.

An area 310 is a rectangular area where the recognized pedestrian 80a may be present. An area 320 is a rectangular area where the recognized pedestrian 80b may be present. The area 310 and the area 320 may be an area having a predetermined size to be occupied by a person. Orientations of the area 310 and the area 310 may be set according to an orientation of a person. The area A1 is an area surrounded by two sides having sections matched with two sides L1 and L2 representing a contour of the area 310 and two sides having sections matched with two sides L3 and L4 representing a contour of the area 320.

Position information of a group included in the alert information may include information indicating coordinates of a center point P0 of the area A1. The position information of the group included in the alert information may include information indicating latitude and longitude coordinates of the center point P0 of the area A1 and a size of the area A1. The position information of the group included in the alert information may include information indicating latitude and longitude coordinates of the center point P0 of the area A1 and lengths of the two sides of the contour of the area A1. The position information of the group included in the alert information may include information indicating latitude and longitude coordinates of two diagonal vertices P1 and P2 of the area A1.

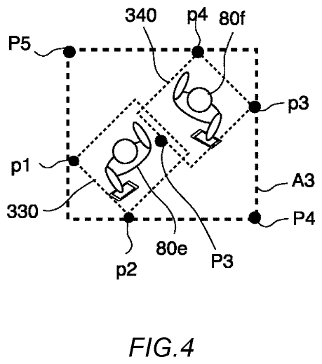

FIG. 4 is an explanatory diagram for describing another example of the position information of the group included in the alert information transmitted by the transmission control unit 250. With reference to FIG. 4, position information of the area A3 of the group including the pedestrian 80e and the pedestrian 80f will be described.

An area 330 is a rectangular area where the recognized pedestrian 80e may be present. An area 340 is a rectangular area where the recognized pedestrian 80f may be present. The area 330 and the area 340 may be an area having a predetermined size to be occupied by a person. Orientations of the area 330 and the area 340 may be set according to an orientation of a person. The area A3 is an area surrounded by two sides including each of two vertices p1 and p2 of a contour of the area 330 and two sides including each of two vertices p3 and p4 of a contour of the area 340.

Position information of a group included in the alert information may include information indicating latitude and longitude coordinates of a center point P3 of the area A3. The position information of the group included in the alert information may include information indicating latitude and longitude coordinates of the center point P3 of the area A3 and a size of the area A3. The position information of the group included in the alert information may include information indicating latitude and longitude coordinates of the center point P3 of the area A3 and lengths of the two sides of the contour of the area A3. The position information of the group included in the alert information may include information indicating latitude and longitude coordinates of diagonal two vertices P4 and P5 of the area A3.

It should be noted that the position information of the group included in the alert information may be information indicating an area of any shape other than a rectangle. The position information of the group included in the alert information may be information indicating an area of a circular shape, an elliptical shape, or any polygonal shape. In addition, the position information of the group included in the alert information may include average coordinates of latitude and longitude coordinates of the plurality of pedestrians 80.

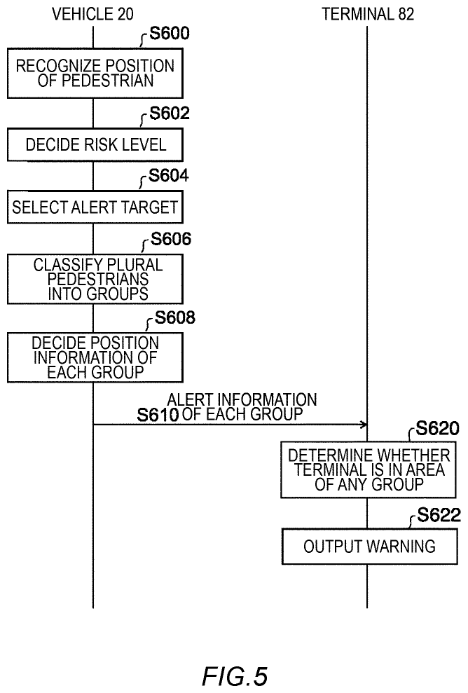

FIG. 5 schematically illustrates a flow of processing related to an alert control method executed by the vehicle 20 and the terminal 82. FIG. 5 illustrates a flow of processing in a case where the alert control apparatus 24 transmits the alert information to the terminal 82 by direct communication.

In S600, the obtaining unit 220 recognizes a position of each of the plurality of pedestrians 80 based on an image picked up by the camera 22. In S602, the risk level decision unit 222 decides a risk level for the vehicle 20. For example, the risk level decision unit 222 decides the risk level to be high in a case where a movement direction of the recognized pedestrian 80 is towards the carriage way 70. The risk level decision unit 222 decides the risk level to be higher as a movement speed of the recognized pedestrian 80 in a direction towards the carriage way 70 is higher. The risk level decision unit 222 decides the risk level to be higher as a position of the recognized pedestrian 80 is closer to the carriage way 70. The risk level decision unit 222 decides the risk level to be high in a case where a distance by which the pedestrian 80 can move within a time period for the vehicle 20 to reach the position of the pedestrian 80 in the advancing direction of the vehicle 20 is longer than a distance from the position of the pedestrian 80 to the carriage way 70. The risk level decision unit 222 decides the risk level of the pedestrian 80 who is recognized as a child to be high.

In S604, the selection unit 230 selects the pedestrians 80 corresponding to the alert targets based on the risk level decided in S602. The selection unit 230 selects the pedestrians 80 whose risk levels are decided to be a predetermined risk level or higher as the alert target among the recognized pedestrians 80.

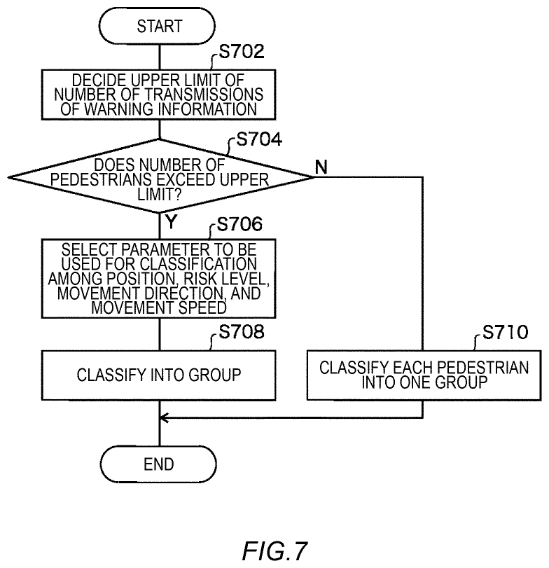

In S606, the classification unit 240 classifies the pedestrians 80 selected in S604 into one or more groups. For example, the classification unit 240 classifies the pedestrians 80 into one or more groups based on at least the positions of the pedestrians 80. The processing in S606 will be described in relation to FIG. 7. In S608, the classification unit 240 decides position information of each of the classified groups. For example, as described in relation to FIG. 3 and FIG. 4, the position information of the group may include latitude and longitude coordinates indicating an area including a range to be occupied by the pedestrians 80 classified into each of the groups. It should be noted that the classification unit 240 may decide the position information of the group so as to include at least the position of the pedestrian 80 whose risk level is decided to be the highest in each of the groups.

In S608, the transmission control unit 250 causes the alert information including position information of each group decided in S608 to be transmitted by broadcast. It should be noted that when a plurality of pieces of alert information are to be transmitted, the transmission control unit 250 may organize the plurality of alert information into one piece of transmission data to be transmitted. When the plurality of pieces of alert information are to be transmitted, the transmission control unit 250 may cause the plurality of pieces of alert information to be transmitted as separate pieces of transmission data.

When the alert information is received, in S620, the terminal 82 identifies, based on the position information of the group included in the alert information, an area to be occupied by pedestrians classified into each group, and determines whether a current position of the terminal 82 itself is included in the identified area. In S622, when the current position of the terminal 82 itself is included in the area identified based on the position information of the group included in the alert information, the terminal 82 performs a warning output through an HMI function of the terminal 82.

It should be noted that when the terminal 82 is to perform the warning output, the terminal 82 may instruct the other terminal 82 located nearby to perform the warning output. For example, the terminal 82 may instruct the other terminal 82 which has been previously associated to perform the warning output. To be specific, the terminal 82 configured to perform the warning output may instruct the other terminal 82 possessed by a family member of a contractor to perform the warning output. The terminal 82 configured to perform the warning output may instruct the other predetermined terminal 82 paired based on Bluetooth (registered trademark) or the like to perform the warning output. The terminal 82 configured to perform the warning output may instruct, by short distance communication, the other terminal 82 located nearby to perform the warning output.

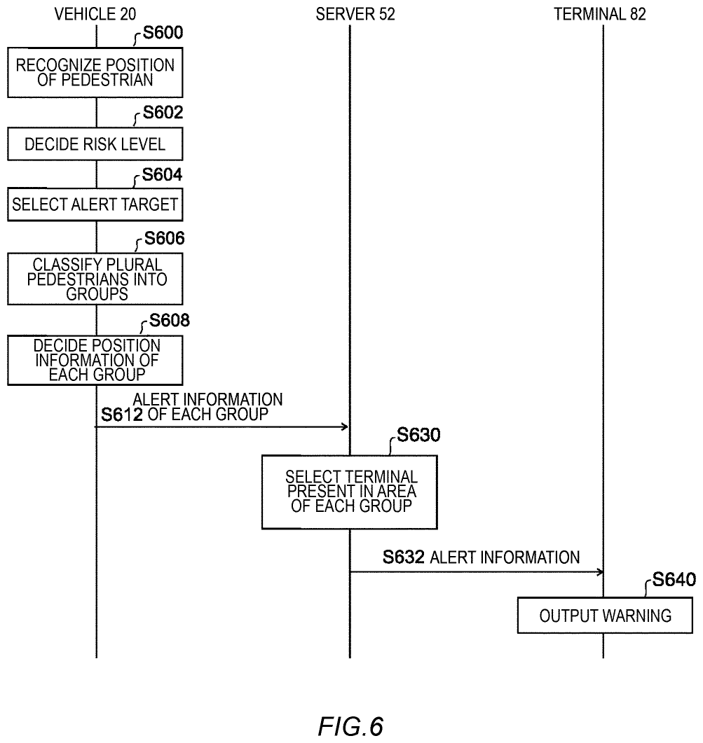

FIG. 6 schematically illustrates a flow of other processing related to the alert control method executed by the vehicle 20, the server 52, and the terminal 82. FIG. 6 illustrates a flow of processing in a case where the alert control apparatus 24 transmits the alert information to the terminal 82 via the server 52. The server 52 collects and stores current position information of the terminal 82. Processing from S600 to S608 in FIG. 6 is the same as the processing from S600 to S608 described in relation to FIG. 5, and descriptions thereof will be omitted.

In S612, the transmission control unit 250 causes the alert information including the position information of each group decided in S608 to be transmitted to a destination of the server 52. When the alert information is received, the server 52 selects the terminal 82 present in the area occupied by the pedestrians classified into each group based on the position information of each group included in the alert information. For example, with reference to the current position information of the terminal 82 stored by the server 52, the server 52 selects the terminal 82 the current position of which is present in the area of each group identified from the position information of each group included in the alert information.

In S632, the server 52 transmits the alert information to the destination of the terminal 82 selected in S630. In S640, the terminal 82 having received the alert information transmitted from the server 52 performs the warning output through the HMI function of the terminal 82.

The driver assistance control apparatus 30 may perform driver assistance of the vehicle 20 together with the transmission of the alert information in S610 in FIGS. 5 and S612 in FIG. 6. For example, when a positional relationship between the pedestrian 80 and the vehicle 20 satisfies a predetermined condition, the driver assistance control apparatus 30 may perform notification of the approach of the pedestrian 80 or the vehicle 20 by deceleration of the vehicle 20, beam passing, or blowing of a horn based on a function of an advanced emergency braking system.

FIG. 7 illustrates a flowchart related to processing for classifying the pedestrians 80 into groups. The flowchart of FIG. 7 can be applied to the processing in S606 in FIG. 5 and FIG. 6.

In S702, the classification unit 240 decides an upper limit of a number of at least one transmission of the alert information. For example, the classification unit 240 decides the upper limit of the number of transmissions of the alert information based on a congestion degree of communication which is obtained by the communication environment information obtaining unit 242. The classification unit 240 decreases the number of transmissions of the alert information as the congestion degree of the communication is higher.

In S704, the classification unit 240 determines whether a number of at least one recognized pedestrian 80 exceeds the upper limit decided in S702. In S704, when it is determined that the number of recognized pedestrians 80 does not exceed the upper limit, the classification unit 240 classifies each of pedestrians among the plurality of pedestrians 80 as one group (S710). That is, when N pedestrians are recognized, the classification unit 240 classifies the pedestrians into N separate pieces of groups.

In S704, when it is determined that the number of recognized pedestrians 80 exceeds the upper limit, in S706, the classification unit 240 selects a parameter among a position, a risk level, a movement direction, and a movement speed of the pedestrian 80 to be used for classification. For example, in a case where it is possible to perform the classification into the upper limit or a fewer number of groups decided in S702 by classifying the pedestrians 80 based on the position, the risk level, the movement direction, and the movement speed of the pedestrian 80, the classification unit 240 selects four parameters including the position, the risk level, the movement direction, and the movement speed of the pedestrian 80 as a combination of the parameters used for the classification. In a case where it is not possible to perform the classification into the upper limit or a fewer number of groups based on the four parameters and a case where it is possible to perform the classification into the upper limit or a fewer number of groups by classifying the pedestrians 80 based on the position, the risk level, and the movement direction of the pedestrian 80, the classification unit 240 selects three parameters of the position, the risk level, and the movement direction of the pedestrian 80 as a combination of the parameters used for the classification. In a case where it is not possible to perform the classification into the upper limit or a fewer number of groups based on the three parameters and a case where it is possible to perform the classification into the upper limit or a fewer number of groups by classifying the pedestrians 80 based on the position and the risk level of the pedestrian 80, the classification unit 240 selects two parameters of the position and the risk level of the pedestrian 80 as a combination of the parameters used for the classification. In a case where it is not possible to perform the classification into the upper limit or a fewer number of groups by classifying the pedestrians 80 based on the two parameters, the classification unit 240 selects only the position of the pedestrian 80 as the parameter used for the classification. Following S706, the classification unit 240 classifies, by using the parameter selected in S706, the pedestrians 80 into the group (S708).

As described above, in accordance with the alert system 10, the alert control apparatus 24 can classify the pedestrians 80 corresponding to the transmission targets of the alert information into a fewer number of group than the number of the pedestrians 80, and transmit the alert information by designating the position information of the group. For this reason, the communication resource used to transmit the alert information can be reduced. Thus, even under a situation where a large number of the pedestrians 80 corresponding to the transmission targets of the alert information are present, a possibility that it is not possible to transmit the alert information can be decreased. In addition, as compared with a case where the alert information including the position information of each of the pedestrians 80 is transmitted, a possibility that the alert information is transmitted in a duplication manner to the plurality of pedestrians 80 located nearby can be decreased.

It should be noted that in the above description, a mode has been described in which the recognition information of the position of the pedestrian 80 is obtained when the vehicle 20 recognizes the position of the pedestrian 80. However, a mode can also be adopted in which the recognition information of the position of the pedestrian 80 recognized by the server 52 or the other vehicle is obtained from the server 52 or the other vehicle.

It should be noted that the communication between the alert control apparatus 24 and the terminal 82 may be performed by short distance direct communication in Cellular-V2X. Examples of the short distance direct communication in Cellular-V2X include communication standards such as LTE-V2X PC5 and 5G-V2X PC5. A mode using Wi-Fi (registered trademark) or dedicated short range communications (DSRC) may be adopted as the direct communication. The alert control apparatus 24 may communicate with the terminal 82 via a base transceiver station. In addition to Cellular-V2X or DSRC (registered trademark), any direct communication standard such as Bluetooth (registered trademark) may be adopted for the communication between the alert control apparatus 24 and the terminal 82. The alert control apparatus 24 may perform the direct communication with the terminal 82 by using communication infrastructure included in intelligent transport systems (ITS).

It should be noted that the vehicle 20 is an example of transport equipment. The transport equipment includes a motor vehicle such as a passenger vehicle or a bus, a riding saddle riding type vehicle, a bicycle, or the like. In addition to a person, the movable object includes transport equipment such as a motor vehicle like a passenger vehicle or a bus, a saddle riding type vehicle, or a bicycle.

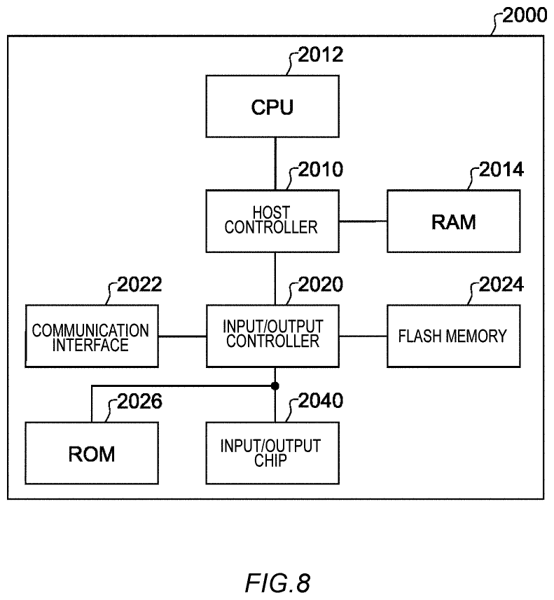

FIG. 8 illustrates an example of a computer 2000 where a plurality of embodiments of the present invention may be entirely or partially embodied. Programs installed in the computer 2000 can cause the computer 2000 to: function as apparatuses such as the alert control apparatus 24 according to the embodiments, or each unit of the apparatuses; execute operations associated with the apparatuses or each unit of the apparatuses; and/or execute a process according to the embodiments or steps of the process. Such programs may be executed by a central processing unit (CPU) 2012 in order to cause the computer 2000 to execute a specific operation associated with some or all of the processing procedures and the blocks in the block diagram described in this specification.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to the programs stored in the ROM 2026 and the RAM 2014, thereby controlling each unit.

The communication interface 2022 communicates with other electronic devices via a network. The flash memory 2024 stores the programs and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a universal serial bus (USB) port, or an HDMI (registered trademark) port.

The programs are provided via a network or a computer readable medium such as a CD-ROM, a DVD-ROM, or a memory card. The RAM 2014, the ROM 2026, or the flash memory 2024 is an example of the computer readable medium. The programs are installed in the flash memory 2024, the RAM 2014, or the ROM 2026, and are executed by the CPU 2012. Information processing written in these programs is read by the computer 2000, and provides cooperation between the programs and the various types of hardware resources described above. An apparatus or a method may be configured by implementing operations or processing of information according to a use of the computer 2000.

For example, when communication is performed between the computer 2000 and an external device, the CPU 2012 may execute a communication program loaded in the RAM 2014, and instruct the communication interface 2022 to execute communication processing based on processing written in the communication program. The communication interface 2022, under the control of the CPU 2012, reads transmission data stored in a transmission buffer processing region provided in a recording medium such as the RAM 2014 and the flash memory 2024, sends the read transmission data to the network, and writes reception data received from the network into a reception buffer processing region or the like provided on the recording medium.

Moreover, the CPU 2012 may cause all or necessary portion of a file or a database stored in the recording medium such as the flash memory 2024 to be read by the RAM 2014, and execute various types of processing on the data on the RAM 2014. Next, the CPU 2012 writes back the processed data into the recording medium.

Various types of programs and various types of information such as data, a table, and a database may be stored in the recording medium, and subjected to information processing. The CPU 2012 may execute, on the data read from the RAM 2014, various types of processing including various types of operations, information processing, conditional judgement, conditional branching, unconditional branching, information retrieval/replacement, or the like described in this specification and specified by instruction sequences of the programs to write back the results into the RAM 2014. Moreover, the CPU 2012 may retrieve information in a file, a database, or the like in the recording medium. For example, when a plurality of entries each having an attribute value of a first attribute associated with an attribute value of a second attribute is stored in the recording medium, the CPU 2012 may retrieve, out of the plurality of entries described above, an entry with the attribute value of the first attribute specified that meets a condition, read the attribute value of the second attribute stored in above described entry, and thereby acquire the attribute value of the second attribute associated with the first attribute meeting a predetermined condition.

The programs or software module described above may be stored on the computer 2000 or in a computer readable medium near the computer 2000. A recording medium such as a hard disk or RAM provided in a server system connected to a dedicated communication network or the Internet can be used as the computer readable medium. The programs stored in the computer readable medium may be provided to the computer 2000 via the network.

The program that is installed in the computer 2000 and causes the computer 2000 to function as the control unit 200 may instruct the CPU 2012 or the like to cause the computer 2000 to function as each unit of the control unit 200. The information processing written in these programs are read by the computer 2000 to cause the computer to function as each unit of the control unit 200, which is specific means realized by the cooperation of software and the various types of hardware resources described above. Then, these specific means implement operations or processing of information according to the intended use of the computer 2000 in the present embodiment, so that the control unit 200 is constructed as a specific control unit according to the intended use.

Various embodiments have been described with reference to the block diagram or the like. In the block diagram, each block may represent (1) a step of a process in which an operation is executed, or (2) each unit of the apparatus having a role in executing the operation. Specific steps and each unit may be implemented by a dedicated circuit, a programmable circuit supplied along with a computer readable instruction stored on a computer readable medium, and/or a processor supplied along with the computer readable instruction stored on the computer readable medium. The dedicated circuit may include a digital and/or analog hardware circuit, or may include an integrated circuit (IC) and/or a discrete circuit. The programmable circuit may include a reconfigurable hardware circuit including: logical AND, logical OR, logical XOR, logical NAND, logical NOR, and other logical operations; a memory element such as a flip-flop, a register, a field programmable gate array (FPGA), a programmable logic array (PLA), or the like; and so on.

The computer readable medium may include any tangible device capable of storing an instruction executed by an appropriate device, so that the computer readable medium having the instruction stored thereon constitutes at least a part of a product including an instruction that may be executed in order to provide means to execute an operation specified by a processing procedure or a block diagram. Examples of the computer readable media may include an electronic storage medium, a magnetic storage medium, an optical storage medium, an electromagnetic storage medium, a semiconductor storage medium, or the like. More specific examples of the computer readable medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disk (DVD), a Blu-ray (registered trademark) disk, a memory stick, an integrated circuit card, or the like.

The computer readable instruction may include either source code or object code written in any combination of one or more programming languages including: an assembler instruction, an instruction-set-architecture (ISA) instruction, a machine instruction, a machine dependent instruction, a microcode, a firmware instruction, state-setting data; or an object oriented programming language such as Smalltalk (registered trademark), JAVA (registered trademark), C++, or the like; and a conventional procedural programming language such as a “C” programming language or a similar programming language.

The computer readable instruction may be provided to a general-purpose computer, a special-purpose computer, or a processor or a programmable circuit of another programmable data processing apparatus, locally or via a local area network (LAN), a wide area network (WAN) such as the Internet or the like, and the computer readable instruction may be executed in order to provide a means to execute operations specified by the described processing procedure or the block diagram. Examples of the processor include a computer processor, a processing unit, a microprocessor, a digital signal processor, a controller, a microcontroller, or the like.

While the embodiments of the present invention have been described, the technical scope of the present invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the present invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10 alert system; 20 vehicle; 21 radar; 22 camera; 24 alert control apparatus; 25 GNSS reception unit; 26 vehicle speed sensor; 29 sensor; 30 driver assistance control apparatus; 48 communication apparatus; 50 base transceiver station; 52 server; 70 carriage way; 72 sidewalk; 80 pedestrian; 82 terminal; 200 control unit; 220 obtaining unit; 222 risk level decision unit; 224 attribute information obtaining unit; 230 selection unit; 240 classification unit; 242 communication environment information obtaining unit; 250 transmission control unit; 280 storage unit; 310, 320, 330, 340 area; 2000 computer; 2010 host controller; 2012 CPU; 2014 RAM; 2020 input/output controller; 2022 communication interface; 2024 flash memory; 2026 ROM; 2040 input/output chip

What is claimed is:

1. An alert control apparatus comprising:
an obtaining unit configured to obtain recognition information including position information of each of a plurality of targets present outside a movable object;
a risk level decision unit configured to decide a risk level for each of the plurality of targets to approach the movable object;
a selection unit configured to select a plurality of targets corresponding to alert targets based on the risk level decided by the risk level decision unit;
a classification unit configured to classify the plurality of targets selected by the selection unit into one or more groups based on the position information of each of the plurality of targets selected by the selection unit; and
a transmission control unit configured to perform control to transmit alert information including position information of the one or more groups.

2. The alert control apparatus according to claim 1, wherein
the recognition information includes position information and a movement direction of each of the plurality of targets present outside the movable object, and
the classification unit is configured to classify, based on the position information and the movement direction of each of the plurality of targets selected by the selection unit, the plurality of targets selected by the selection unit into one or more groups.

3. The alert control apparatus according to claim 2, wherein
the recognition information includes the position information, the movement direction, and a movement speed of each of the plurality of targets present outside the movable object, and
the classification unit is configured to classify, based on the position information, the movement direction, and the movement speed of each of the plurality of targets selected by the selection unit, the plurality of targets selected by the selection unit into one or more groups.

4. The alert control apparatus according to claim 1, wherein the transmission control unit is configured to perform control to transmit the alert information including center coordinates of position information of a plurality of targets classified into each group.

5. The alert control apparatus according to claim 1, wherein the transmission control unit is configured to perform control to transmit the alert information including a plurality of pieces of coordinate information indicating an area including position information of a plurality of targets classified into each group.

6. The alert control apparatus according to claim 1, wherein the transmission control unit is configured to perform control to transmit the alert information including a position of a target whose risk level is the highest decided by the risk level decision unit among a plurality of targets classified into each group.

7. The alert control apparatus according to claim 1, wherein the obtaining unit is configured to obtain the recognition information by performing image recognition of an image picked up by an image pickup unit mounted on the movable object.

8. The alert control apparatus according to claim 1, wherein
the plurality of targets are persons,
the alert control apparatus further comprises an attribute information obtaining unit configured to obtain information indicating an age of each of the plurality of targets, and
the risk level decision unit is configured to decide the risk level to be higher in a case where the ages of the plurality of targets are included in a predetermined age group as compared with a case where the ages of the plurality of targets are not included in the predetermined age group.

9. The alert control apparatus according to claim 1, further comprising:
a communication environment information obtaining unit configured to obtain information indicating a communication environment, wherein
the classification unit is configured to decide a number of at least one group for classifying the plurality of targets selected by the selection unit based on the communication environment obtained by the communication environment information obtaining unit.

10. The alert control apparatus according to claim 9, wherein
the communication environment information obtaining unit is configured to obtain information indicating a congestion degree of the communication environment, and
the classification unit is configured to decrease the number of groups for classifying the plurality of targets selected by the selection unit as the congestion degree obtained by the communication environment information obtaining unit is higher.

11. The alert control apparatus according to claim 1, wherein the transmission control unit is configured to perform control to transmit the alert information without designating a destination.

12. The alert control apparatus according to claim 1, wherein the transmission control unit is configured to perform control to transmit the alert information to a server configured to manage position information of a plurality of mobile terminals, and transmit the alert information through the server.

13. The alert control apparatus according to claim 2, wherein the transmission control unit is configured to perform control to transmit the alert information including center coordinates of position information of a plurality of targets classified into each group.

14. The alert control apparatus according to claim 2, wherein the transmission control unit is configured to perform control to transmit the alert information including a plurality of pieces of coordinate information indicating an area including position information of a plurality of targets classified into each group.

15. The alert control apparatus according to claim 2, wherein the transmission control unit is configured to perform control to transmit the alert information including a position of a target whose risk level is the highest decided by the risk level decision unit among a plurality of targets classified into each group.

16. The alert control apparatus according to claim 3, wherein the transmission control unit is configured to perform control to transmit the alert information including a position of a target whose risk level is the highest decided by the risk level decision unit among a plurality of targets classified into each group.

17. The alert control apparatus according to claim 1, wherein the movable object is a vehicle.

18. A movable object comprising the alert control apparatus according to claim 1.

19. An alert control method comprising:
obtaining recognition information including position information of each of a plurality of targets present outside a movable object;
deciding a risk level for each of the plurality of targets to approach the movable object;
selecting a plurality of targets corresponding to alert targets based on the decided risk level;
classifying the plurality of selected targets into one or more groups based on the position information of each of the plurality of selected targets; and
performing control to transmit alert information including position information of the one or more groups.

20. A non-transitory computer storage medium having stored thereon a program for causing a computer to execute:
obtaining recognition information including position information of each of a plurality of targets present outside a movable object;
deciding a risk level for each of the plurality of targets to approach the movable object;
selecting a plurality of targets corresponding to alert targets based on the decided risk level;
classifying the plurality of selected targets into one or more groups based on the position information of each of the plurality of selected targets; and
performing control to transmit alert information including position information of the one or more groups.
